(19) United States
(12) Patent Application Publication
(10) Pub. No.: US 2009/0088235 A1
(43) Pub. Date: Apr. 2, 2009

(54) CONCENTRIC PUZZLE VIDEO GAME

(75) Inventor: Robert Kenneth Stein, III, Redmond, WA (US)

Correspondence Address: DARBY & DARBY P.C., P.O. BOX 770, Church Street Station, New York, NY, 10008-0770, US

(73) Assignee: Duael Designs LLC

(21) Appl. No.: 11/864,232

(22) Filed: Sep. 28, 2007

(51) Int. Cl. A63F 13/00

(52) U.S. Cl. 463/9; 463/31; 463/35; 463/42; 463/43; 463/46

(57) ABSTRACT

A device, system, and method are directed towards playing a concentric puzzle video game. A definition is employed to arrange at least one operation and a display of the game. The definition includes content for configuring the display. The display of the game is arranged to include a plurality of concentric rings. At least a portion of the content is displayed on at least one of the concentric rings. At least one of the plurality of concentric rings that the portion of the content is displayed on is rotated. An initial ordering of at least one portion of the displayed content is changed by a rotation of at least one of the plurality of the concentric rings. An input rotates a selected ring of the plurality of concentric rings. The initial ordering of at least one portion of the displayed content is restorable by the input.

### FIELD OF THE INVENTION

The present invention relates generally to casual games and, more particularly, but not exclusively to providing a puzzle game on a mobile device.

### BACKGROUND

Players of video games have less time to play games on the go. Video games are increasingly provided on mobile devices, or the like. Games may be short, but must be interesting and challenging. These short video games have been referred to as casual games. Moreover, players generally enjoy puzzle games with sufficient difficulties and challenges. It is with respect to this consideration and others that the current invention is directed.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIG. 1 shows a networked environment illustrating one embodiment of one environment for practicing the invention;

FIG. 2 shows one embodiment of a mobile device that may be included in a system implementing the invention;

FIG. 3 shows one embodiment of a network device that may be included in a system implementing the invention;

FIG. 4 illustrates a logical flow diagram generally showing embodiments of a process for playing a concentric puzzle video game;

FIGS. 5A and 5B show a plurality of processes for applying a plurality of rotation rules to enable changing a configuration of a concentric puzzle video game;

FIG. 6 shows another process flow diagram generally showing one embodiment of a process for enabling control of a concentric puzzle video game;

FIG. 7 shows an example of a process flow through a plurality of control screens for selecting and controlling the game;

FIG. 8 shows a process for providing a hint for a concentric ring to move to assist in completion of a game;

FIG. 9 shows a process for determining completion of the concentric puzzle video game;

FIG. 10 shows a process for enabling a multi-player online tournament mode of the concentric puzzle video game;

FIG. 11 shows a process for personalizing and/or customizing content and a game definition of a concentric puzzle video game; and

FIG. 12 an example definition for a concentric puzzle video game, in accordance with the present invention.

### DETAILED DESCRIPTION OF THE INVENTION

The present invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention. In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.” As used herein, the terms “device input” or “user input” refer to a user input command at a device.

Briefly, the present invention is directed to a device, system, and method for playing a concentric puzzle video game. A definition is employed to arrange at least one operation and a display of the game. The definition includes content for configuring the display. The display of the game is arranged to include a plurality of concentric rings. At least a portion of the content is displayed on at least one of the concentric rings. The at least one of the plurality of concentric rings that the portion of the content is displayed on is rotated. An initial ordering of the at least one portion of the displayed content is changed by a rotation of the at least one of the plurality of the concentric rings. A user may be provided a hint on which ring to select and/or rotate. A device input rotates a selected ring of the plurality of concentric rings. The initial ordering of the at least one portion of the displayed content is restorable by the input.

In one embodiment, a user on a client may be enabled to provide custom content and/or custom definitions of the game. The user may share the personalized custom content and/or definition with other clients, for the other clients to play the game based on the shared information.

In one embodiment, a plurality of clients may play the same game in a multi-player online tournament mode based on the same definition of the game.

Generally, one goal of the concentric puzzle video game is to restore the scrambled image displayed on the rings, however, other goals, including finishing the game within a particular time, in a particular order, or the like, may also be enabled without departing from the scope of the invention.

As used herein, the concentric puzzle video game described herein may be referred to as a “puzzle video game,” or simply “game”. Entry of an input may select a ring for control. The ring is referred to as a “selected” ring. The selected ring is also referred to as a “parent”, and all other rings in the concentric video game puzzle are referred to as a “child” or “children”. As used herein, the term “player” or “user” is any operator of a client device enabled to control the concentric puzzle video game.

As used herein, the term “ring” refers to any enclosed shape capable of being rotated. The ring may be circular, elliptical, square, polygonal, or virtually any enclosed shape. The plurality of concentric rings described herein may be homogenous or heterogeneous. For example, a square ring may be enclosed inside a circular ring.

In one embodiment, a concentric puzzle video game may include a plurality of levels. At least one level may include a plurality of puzzles. Each puzzle may include concentric rings, rotation patterns, rotation rules, images, or the like.

As described herein, the invention may be embodied in a processor readable medium, method, system, and apparatus, or the like. As used herein, the term “client” may include any computing device in communication with a network, including a mobile device, a personal computer, an embedded device, a cellular telephone, personal digital assistant (PDA), notebook computer, smart phone, Sidekick, Blackberry, or the like.

### Illustrative Operating Environment

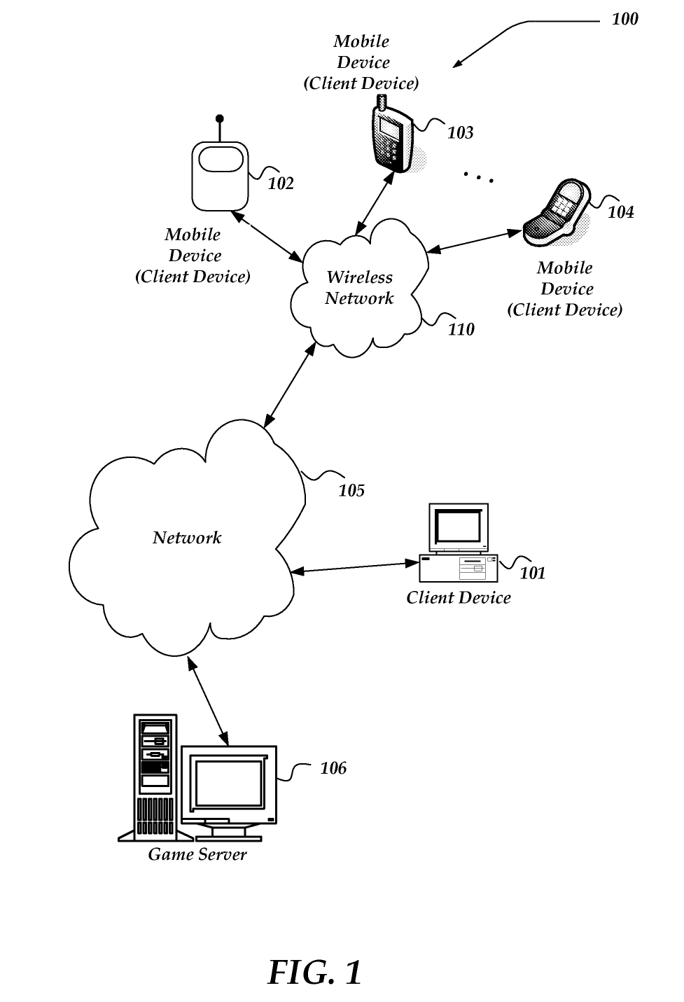

FIG. 1 shows components of one embodiment of an environment in which the invention may be practiced. Not all the components may be required to practice the invention, and variations in the arrangement and type of the components may be made without departing from the spirit or scope of the invention. As shown, system 100 of FIG. 1 includes network 105 (comprising one or more local area networks (“LANs”)/wide area networks (“WANs”), wireless network 110, mobile devices (client devices) 102-104, client device 101, and game server 106.

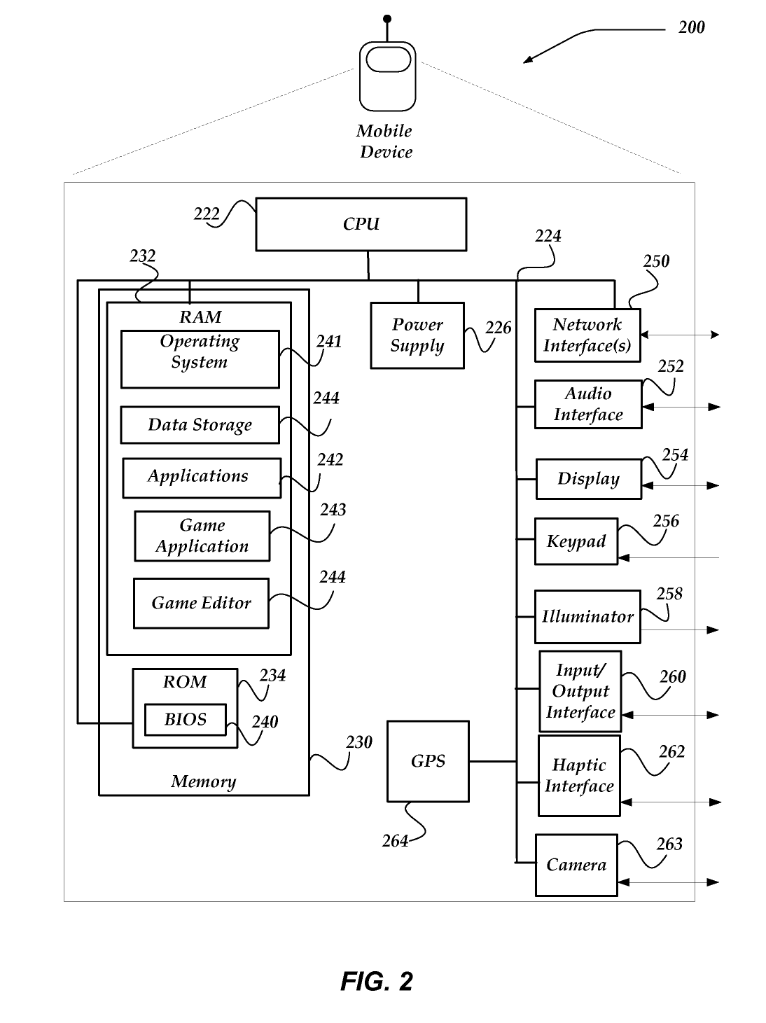

One embodiment of mobile devices 102-104 is described in more detail below in conjunction with FIG. 2. Generally, however, mobile devices 102-104 may include virtually any portable computing device capable of receiving and sending a message over a network, such as network 105, wireless network 110, or the like. Mobile devices 102-104 may also be described generally as client devices that are configured to be portable. Thus, mobile devices 102-104 may include virtually any portable computing device capable of connecting to another computing device and receiving information. Such devices include portable devices such as, cellular telephones, smart phones, display pagers, radio frequency (RF) devices, infrared (IR) devices, Personal Digital Assistants (PDAs), handheld computers, laptop computers, wearable computers, tablet computers, integrated devices combining one or more of the preceding devices, and the like. As such, mobile devices 102-104 typically range widely in terms of capabilities and features. For example, a cell phone may have a numeric keypad and a few lines of monochrome LCD display on which only text may be displayed. In another example, a web-enabled mobile device may have a touch sensitive screen, a stylus, and several lines of color LCD display in which both text and graphics may be displayed.

A web-enabled mobile device may include a browser application that is configured to receive and to send web pages, web-based messages, and the like. The browser application may be configured to receive and display graphics, text, multimedia, and the like, employing virtually any web based language, including a wireless application protocol messages (WAP), and the like. In one embodiment, the browser application is enabled to employ Handheld Device Markup Language (HDML), Wireless Markup Language (WML), WMLScript, JavaScript, Standard Generalized Markup Language (SMGL), HyperText Markup Language (HTML), Dynamic HTML, AJAX, CSS, eXtensible Markup Language (XML), and the like, to display and send a message.

Mobile devices 102-104 also may include at least one other client application that is configured to receive content from another computing device. The client application may include a capability to provide and receive textual content, graphical content, audio content, and the like. The client application may further provide information that identifies itself, including a type, capability, name, and the like. In one embodiment, mobile devices 102-104 may uniquely identify themselves through any of a variety of mechanisms, including a phone number, Caller ID, SIM card ID, manually entered PIN, username, user ID, password, MAC address, IPv6 address, Mobile Identification Number (MIN), an electronic serial number (ESN), or other mobile device identifier. The information may also indicate a content format that the mobile device is enabled to employ. Such information may be provided in a message, or the like, sent to game server 106, client device 101, or other computing devices. Moreover, mobile devices 102-104 may further provide information associated with its physical location to another computing device.

Mobile devices 102-104 may also be configured to communicate a message, such as through Short Message Service (SMS), Multimedia Message Service (MMS), instant messaging (IM), internet relay chat (IRC), Mardam-Bey's IRC (mIRC), Jabber, AOL/AIM, MSN, GoogleTalk, Skype, Vonage, Email, and the like, between another computing device, such as game server 106, client device 101, or the like. However, the present invention is not limited to these message protocols, and virtually any other message protocol may be employed.

Mobile devices 102-104 may be further configured to enable a user to participate in communications sessions, such as IM sessions. As such, mobile devices 102-104 may include a client application that is configured to manage various actions on behalf of the client device. For example, the client application may enable a user to interact with the browser application, email application, IM applications, SMS application, and the like.

Mobile devices 102-104 may further be configured to include a client application that enables the end-user to log into an end-user account that may be managed by another computing device, such as game server 106. Such end-user account, for example, may be configured to enable the end-user to receive emails, send/receive IM messages, SMS messages, access selected web pages, participate in a social networking activity, or the like. Mobile devices 102-104 may also communicate with non-mobile client devices, such as client device 101, or the like.

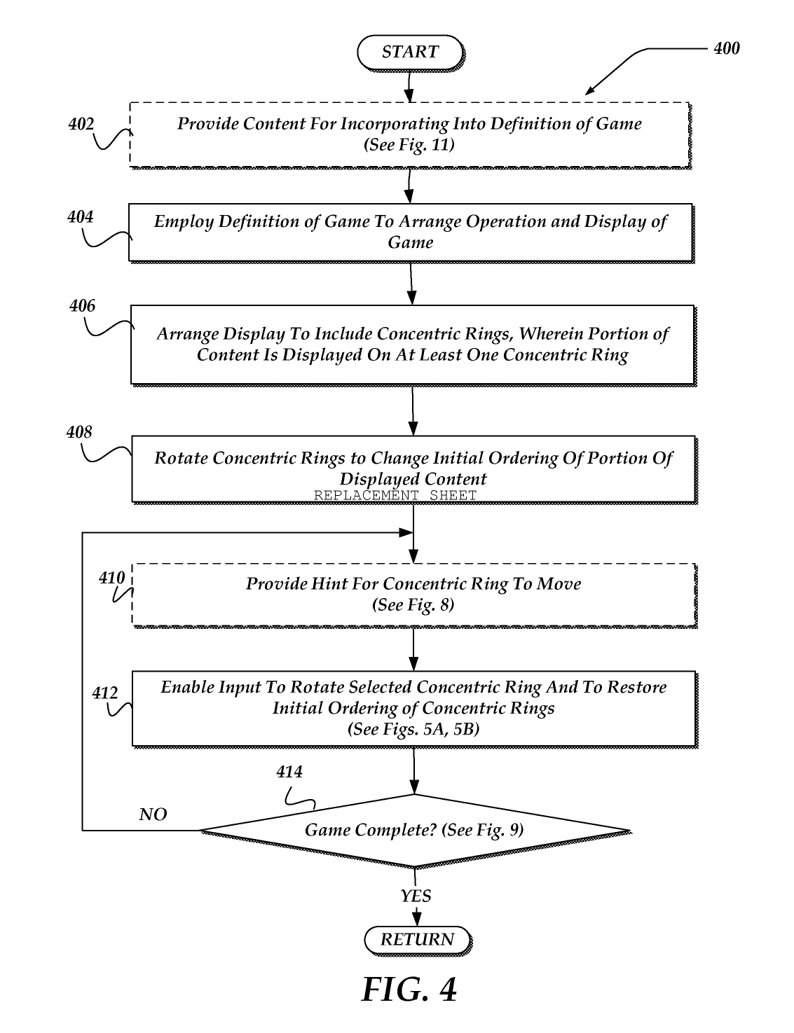

In one embodiment, mobile devices 102-104 may be configured to perform the operations described in the processes of FIGS. 4-7. Briefly, mobile devices 102-104 may display a concentric puzzle video game on a display to a player, initialize the rotations of a plurality of the concentric rings in the game, enable the player to enter at least one input to select and/or control the rotation of a selected ring based on a rotation rule, detect the completion of the game, and/or display the game results (e.g., statistics about the play of the game), including number of moves, time of game play, or the like. In one embodiment, mobile devices 102-104 may be enabled to play a multi-player online tournament mode. In this embodiment at least two of mobile devices 102-104 may receive the same definition of the game. The players using the mobile devices 102-104 may play the game and may send the game results of the game to game server 106 and/or to each other. In one embodiment, game server 106 may forward the results to the mobile devices 102-104. In one embodiment, the game results may be posted to a website. In one embodiment, the multi-player online tournament mode may enable the players to play at substantially the same time and/or within substantially the same time limit.

Client device 101 may include virtually any computing device capable of communicating over a network to send and receive information, including social networking information, or the like. The set of such devices may include devices that typically connect using a wired or wireless communications medium such as personal computers, multiprocessor systems, microprocessor-based or programmable consumer electronics, network PCs, or the like. Moreover, client device 101, although representing a computing device that is non-mobile, may be configured to perform many of the actions described above for mobile devices 102-104. In addition, in at least one embodiment, client device 101 may also provide information, such as a MAC address, IP address GPS coordinates, latitude/longitude, IPv6 address, Unique Processor ID (such as on Intel's CPUs), or the like, useable to determine its physical location.

Wireless network 110 is configured to couple mobile devices 102-104 and its components with network 105. Wireless network 110 may include any of a variety of wireless sub-networks that may further overlay stand-alone ad-hoc networks, and the like, to provide an infrastructure-oriented connection for mobile devices 102-104. Such sub-networks may include mesh networks, Wireless LAN (WLAN) networks, cellular networks, and the like.

Wireless network 110 may further include an autonomous system of terminals, gateways, routers, and the like connected by wireless radio links, and the like. These connectors may be configured to move freely and randomly and organize themselves arbitrarily, such that the topology of wireless network 110 may change rapidly.

Wireless network 110 may further employ a plurality of access technologies including second (2G), third (3G) generation radio access for cellular systems, EDGE, VoIP, 802.11a/b/g, WiMax, WLAN, Wireless Router (WR) mesh networks, and the like. Access technologies such as 2G, 3G, and future access networks may enable wide area coverage for mobile devices, such as mobile devices 102-104 with various degrees of mobility. For example, wireless network 110 may enable a radio connection through a radio network access such as Global System for Mobile communication (GSM), General Packet Radio Services (GPRS), Enhanced Data GSM Environment (EDGE), Wideband Code Division Multiple Access (WCDMA), and the like. In essence, wireless network 110 may include virtually any wireless communication mechanism by which information may travel between mobile device s 102-104 and another computing device, network, and the like.

Network 105 is configured to couple game server 106 and its components with other computing devices, including, mobile devices 102-104, client device 101, and through wireless network 110 to mobile devices 102-104. Network 105 is enabled to employ any form of computer readable media for communicating information from one electronic device to another. Also, network 105 can include the Internet in addition to local area networks (LANs), wide area networks (WANs), direct connections, such as through a universal serial bus (USB) port, other forms of computer-readable media, CAT5, CAT5e, Fiber, DSL, Cable Modem, A/C power networks, POTS, Ethernet, T1, Frame Relay, or any combination thereof. On an interconnected set of LANs, including those based on differing architectures and protocols, a router acts as a link between LANS, enabling messages to be sent from one to another. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DLSLs), wireless links including satellite links, or other communications links known to those skilled in the art. Furthermore, remote computers and other related electronic devices could be remotely connected to either LANs or WANs via a modem and temporary telephone link. In essence, network 105 includes any communication method by which information may travel between game server 106, client device 101, and other computing devices.

Additionally, communication media typically embodies computer-readable instructions, data structures, program modules, or other data in a modulated data signal such as a carrier wave, data signal, or other transport mechanism and includes any information delivery media. The terms “modulated data signal,” and “carrier-wave signal” includes a signal that has one or more of its characteristics set or changed in such a manner as to encode information, instructions, data, and the like, in the signal. By way of example, communication media includes wired media such as twisted pair, coaxial cable, fiber optics, wave guides, and other wired media and wireless media such as acoustic, RF, infrared, and other wireless media.

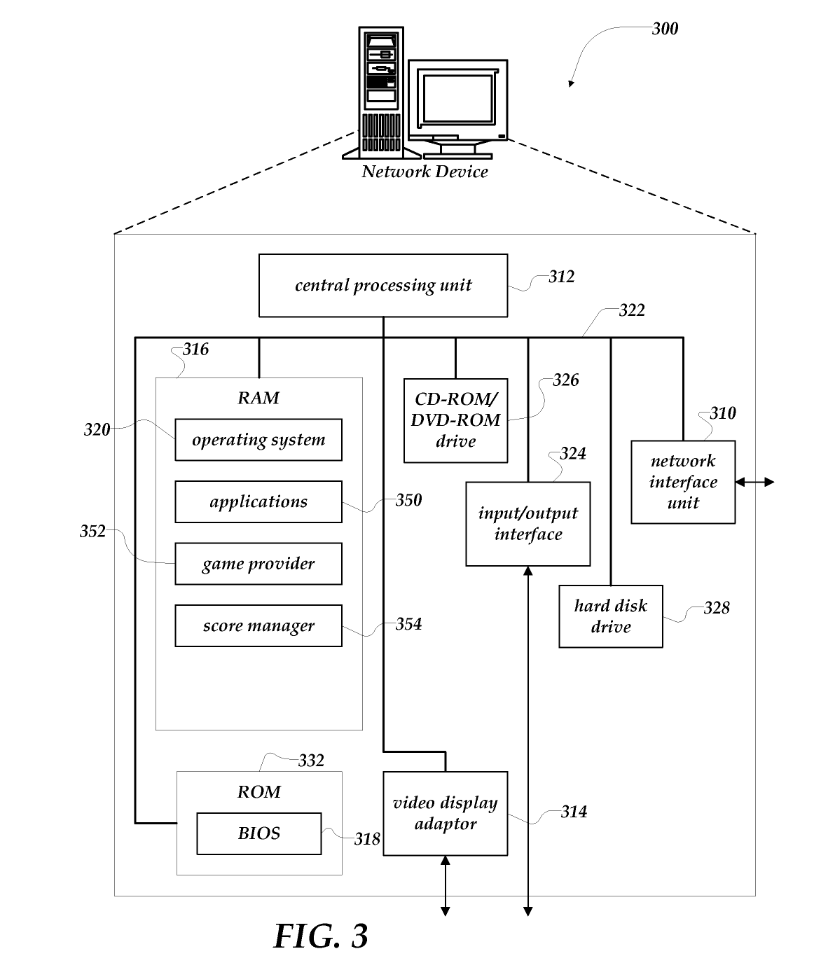

One embodiment of game server 106 is described in more detail below in conjunction with FIG. 3. Devices that may operate as game server 106 include personal computers, desktop computers, multiprocessor systems, microprocessor-based or programmable consumer electronics, network PCs, servers, and the like. Although FIG. 1 illustrates game server 106 as a single computing device, the invention is not so limited. For example, one or more functions of game server 106 may be distributed across one or more distinct computing devices. In one embodiment, game server 106 may be configured to provide a copy of the concentric puzzle video game over network 105. In one embodiment, game server 106 may receive an update of the definition of the game, including content, level files, rotation rules, or the like from another device over networks 105 and/or 110. For example, game server 106 may receive an image, video, sound, or any content from client device 101 and/or one of mobile devices 102-104 (e.g., captured with a camera). The content may be associated with a player. The content may be incorporated into a personalized definition of a game which uses the received content. The personalized definition may be sent to the player for future play, shared between players, or the like. In one embodiment, the personalized definition may be configured to be shared by any communication mechanism, including email, SMS, posting on a web site, or the like. In one embodiment, the player may restrict access to those who can receive the personalized definition of the game.

In one embodiment, game server 106 may provide a (new, personalized and/or updated) definition of the game. A definition of the game may comprise a plurality of level files. A level file may include rotation patterns, rotation rules, graphics, video, images, sounds, controls, or the like. In one embodiment, game server 106 may also send, receive, and/or store game statistics, including information about a “Hall of Fame” for players of the game. In another embodiment, the game statistics may be from a multi-player online tournament mode.

### Illustrative Mobile Client Environment

FIG. 2 shows one embodiment of mobile device 200 that may be included in a system implementing at least one embodiment of the invention. Mobile device 200 may include many more or less components than those shown in FIG. 2. However, the components shown are sufficient to disclose an illustrative embodiment for practicing the present invention. Mobile device 200 may represent, for example, mobile devices 102-104 of FIG. 1.

As shown in the figure, mobile device 200 includes a processing unit (CPU) 222 in communication with a mass memory 230 via a bus 224. Mobile device 200 also includes a power supply 226, one or more network interfaces 250, an audio interface 252, a display 254, a keypad 256, an illuminator 258, an input/output interface 260, a haptic interface 262, an optional global positioning systems (GPS) receiver 264 and camera 263. Power supply 226 provides power to mobile device 200. A rechargeable or non-rechargeable battery may be used to provide power. The power may also be provided by an external power source, such as an AC adapter or a powered docking cradle that supplements and/or recharges a battery.

Mobile device 200 may optionally communicate with a base station (not shown), or directly with another computing device. Network interface 250 includes circuitry for coupling mobile device 200 to one or more networks, and is constructed for use with one or more communication protocols and technologies including, but not limited to, global system for mobile communication (GSM), code division multiple access (CDMA), time division multiple access (TDMA), user datagram protocol (UDP), transmission control protocol/Internet protocol (TCP/IP), SMS, general packet radio service (GPRS), WAP, ultra wide band (UWB), IEEE 802.16 Worldwide Interoperability for Microwave Access (WiMax), SIP/RTP, or any of a variety of other wireless communication protocols. Network interface 250 is sometimes known as a transceiver, transceiving device, or network interface card (NIC).

Audio interface 252 is arranged to produce and receive audio signals such as the sound of a human voice, alarms, tones, music, noise, or the like. For example, audio interface 252 may be coupled to a speaker and microphone (not shown) to enable telecommunication with others and/or generate an audio acknowledgement for some action. Display 254 may be a liquid crystal display (LCD), Vacuum Florescent Display (VFD) gas plasma, light emitting diode (LED), or any other type of display used with a computing device. Display 254 may also include a touch sensitive screen arranged to receive input from an object such as a stylus or a digit from a human hand.

Keypad 256 may comprise any input device arranged to receive input from a user. For example, keypad 256 may include a push button numeric dial, or a keyboard. Keypad 256 may also include command buttons that are associated with selecting and sending images. Illuminator 258 may provide a status indication and/or provide light. Illuminator 258 may remain active for specific periods of time or in response to events. For example, when illuminator 258 is active, it may backlight the buttons on keypad 256 and stay on while the client device is powered. Also, illuminator 258 may backlight these buttons in various patterns when particular actions are performed, such as dialing another client device. Illuminator 258 may also cause light sources positioned within a transparent or translucent case of the client device to illuminate in response to actions.

Mobile device 200 also comprises input/output interface 260 for communicating with external devices, such as a headset, or other input or output devices not shown in FIG. 2. Input/output interface 260 can utilize one or more communication technologies, such as USB, infrared, Bluetooth™, or the like. Haptic interface 262 is arranged to provide tactile feedback to a user of the client device. For example, the haptic interface may be employed to vibrate mobile device 200 in a particular way when another user of a computing device is calling.

Camera 263 is arranged to provide a still or moving image to the user and/or to send or receive such image over network interface 250. In one embodiment, camera 263 may be a charged-coupled-device (CCD) digital camera, or the like.

Optional GPS transceiver 264 can determine the physical coordinates of mobile device 200 on the surface of the Earth, which typically outputs a location as latitude and longitude values. GPS transceiver 264 can also employ other geo-positioning mechanisms, including, but not limited to, triangulation, assisted GPS (AGPS), E-OTD, CI, SAI, ETA, BSS, SIRF, or the like, to further determine the physical location of mobile device 200 on the surface of the Earth. It is understood that under different conditions, GPS transceiver 264 can determine a physical location within millimeters for mobile device 200; and in other cases, the determined physical location may be less precise, such as within a meter or significantly greater distances. In one embodiment, however, mobile device 200 may, through other components, provide other information that might be employed to determine a physical location of the device, including for example, a MAC address, IP address, Cellular Tower, or the like.

Mass memory 230 includes a RAM 232, a ROM 234, and other storage means. Mass memory 230 illustrates another example of computer storage media for storage of information such as computer readable instructions, data structures, program modules or other data. Mass memory 230 stores a basic input/output system (“BIOS”) 240 for controlling low-level operation of mobile device 200. The mass memory also stores an operating system 241 for controlling the operation of mobile device 200. It will be appreciated that this component may include a general purpose operating system such as a version of UNIX, or LINUX™, including embedded LINUX™, or a specialized client communication operating system such as Windows Mobile™, Palm OS or the Symbian® operating system. The operating system may include, or interface with a Java virtual machine module that enables control of hardware components and/or operating system operations via Java application programs.

Memory 230 further includes one or more data storage 244, which can be utilized by mobile device 200 to store, among other things, applications 242 and/or other data. For example, data storage 244 may also be employed to store information that describes various capabilities of mobile device 200. The information may then be provided to another device based on any of a variety of events, including being sent as part of a header during a communication, sent upon request, or the like.

Applications 242 may include computer executable instructions which, when executed by mobile device 200, transmit, receive, and/or otherwise process messages (e.g., SMS, MMS, IM, email, and/or other messages), audio, video, and enable telecommunication with another user of another client device. Other examples of application programs include calendars, browsers including Web browsers, RSS feed readers, contact manager, photo viewer, video replay and recorder, audio playback and recording (such as MP3), camera, email clients, IM applications, SMS applications, VOIP applications, contact managers, task managers, transcoders, database programs, word processing programs, security applications, spreadsheet programs, games, search programs, and so forth. Applications 242 may include game application 243.

Mobile device 200 can be configured to receive a definition of game application 243 over network interface 250. In one embodiment, the definition of game application 243 may be received from game server 105 over network 105 of FIG. 1 via wireless network 110, or the like. Based on the received definition, mobile device 200 may execute or otherwise install game application 243 within, for example, applications 242. In one embodiment, game application 243 may be configured to perform the processes of FIGS. 4-7. Game application 243 may be launched from a desktop controlled and/or displayed by operating system 241. The desktop may be displayed on display 254. The game application may present a user interface on display 254. Game application 243 may receive control inputs, such as key-presses, mouse controls, roll button controls, voice commands, or the like via input/output interface 260 and/or audio interface 252, or the like. Control inputs may cause at least one ring in the concentric puzzle video game to rotate based on a rotation rule. Game application 243 may store game results, such as scores, of played games in data storage 244. In one embodiment, the game results may be stored in data storage 244, and/or sent/received over network interface(s) 250. Game application 243 may also communicate game results/statistics over network interface 250 to, for example, game server 105. In one embodiment, the game results may be from a multi-player online tournament mode. In one embodiment, game application 243 may receive a (new, updated, or personalized) game definition of the game, including a plurality of levels of a puzzle over network interface 250 from, for example, game server 105.

Game editor 244 includes any component for managing content and/or a definition of the game. Game editor 244 may enable input/output interface 260, camera 263, audio interface 252, and/or network interface 250 to capture and/or receive the content. In one embodiment, the content may be received over a network. Game editor 244 may include a plurality of user interface screens for selecting, modifying content, and/or incorporating (associating) the content with the definition. In one embodiment, game editor 244 may enable editing the game definition levels, rotation patterns, or the like. In one embodiment, game editor 244 may enable a text edit of the definition.

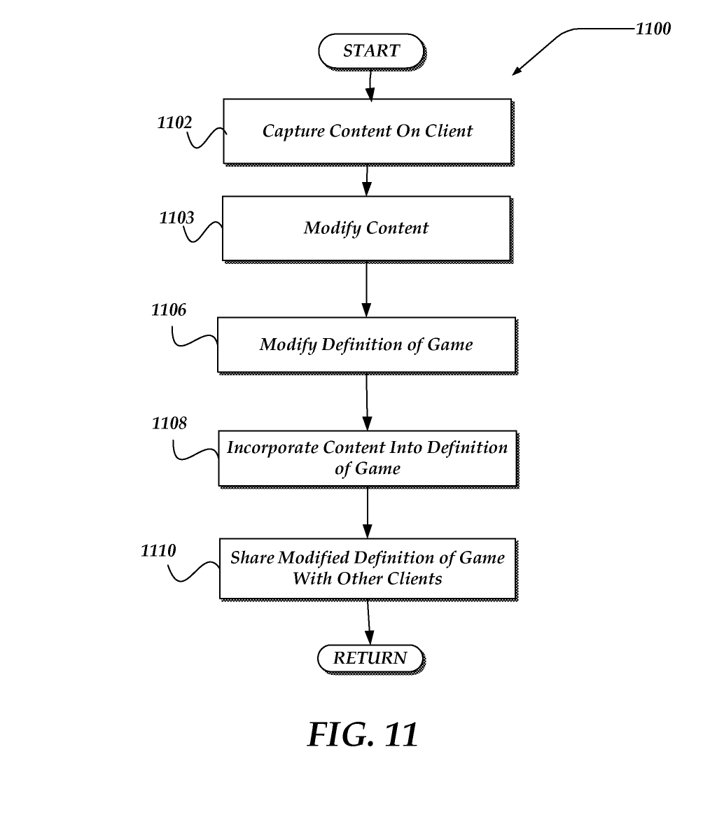

In one embodiment, game editor 244 may be configured to send over network interface 250 to a game sever, the content and/or definition to be incorporated into another definition of the game. The other definition may be shared with other clients for game play based on the other definition. In one embodiment, game editor 244 may perform process 1100 of FIG. 11.

### Illustrative Server Environment

FIG. 3 shows one embodiment of a network device, according to one embodiment of the invention. Network device 300 may include many more components than those shown. The components shown, however, are sufficient to disclose an illustrative embodiment for practicing the invention. Network device 300 may represent, for example, game server 106 of FIG. 1.

Network device 300 includes central processing unit 312, video display adapter 314, and a mass memory, all in communication with each other via bus 322. The mass memory generally includes RAM 316, ROM 332, and one or more permanent mass storage devices, such as hard disk drive 328, tape drive, CD-ROM/DVD-ROM drive 326, and/or floppy disk drive. The mass memory stores operating system 320 for controlling the operation of network device 300. Any general-purpose operating system may be employed. Basic input/output system (“BIOS”) 318 is also provided for controlling the low-level operation of network device 300. As illustrated in FIG. 3, network device 300 also can communicate with the Internet, or some other communications network, via network interface unit 310, which is constructed for use with various communication protocols including the TCP/IP protocol. Network interface unit 310 is sometimes known as a transceiver, transceiving device, or network interface card (NIC).

The mass memory as described above illustrates another type of computer-readable media, namely computer storage media. Computer storage media may include volatile, nonvolatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, Digital Video Disc(DVD) or other optical storage, holographic, nanotube, atomic, biological, magnetic cassettes, magnetic tape, magnetic disk storage or other magnetic storage devices, or any other medium which can be used to store the desired information and which can be accessed by a computing device.

The mass memory also stores program code and data. One or more applications 350 are loaded into mass memory and run on operating system 320. Examples of application programs may include transcoders, schedulers, calendars, database programs, word processing programs, HTTP programs, customizable user interface programs, IPSec applications, encryption programs, security programs, VPN programs, SMS message servers, IM message servers, email servers, account management and so forth. Game provider 353 and/or score manager 354 may also be included as one or more application programs within applications 350.

Game provider 350 includes any component configured to provide a definition of a concentric puzzle video game, including level files, images, rotation patterns, controls, or the like. The definition of the game may be provided over network interface unit 310, for example. The definition may be new information to a player and/or mobile device, updated information, and/or personalized information including content particular to the player and/or mobile device. In one embodiment, game provider 350 may receive information over network interface unit 310 for updating the definition. The information may be multimedia information, including an image, a sound, a ring tone, an animation, a video, or the like.

Score manager 354 includes any component configured to send, receive, and/or store game results, including statistics about the game play of the concentric puzzle video game. In one embodiment, score manager 354 may receive the game results over network 310 from, for example, a mobile device. The game results may be from a multi-player online tournament mode. The game results may include player identity, number of moves to solve a puzzle(s), or the like. Such information may be stored in hard disk drive 328, for example. In one embodiment, the game results may be provided to a client device over network 310.

### Illustrative Operation

FIGS. 4-11 illustrate logical flow diagrams generally showing embodiments of processes for playing a concentric puzzle video game. The process shown in FIGS. 4-11 may be implemented with mobile devices 102-104, client device 101, and/or game server 106 of FIG. 1.

Process 400 of FIG. 4 begins, after a start block, at block 402 where content is provided to the server to personalize a definition of the game. The process of block 402 is described in more detail in conjunction with FIG. 11. In one embodiment, block 402 may be optional and may not be performed. Processing then continues to block 404.

At block 404, the definition for the game is employed to arrange at least one operation of the game and a display of the game. In one embodiment, the definition may comprise content (e.g., images, sound, video), a shape for each concentric ring, a rotation pattern(s), a rotation rule(s), levels, or the like. The definition may be received over a network at a mobile device. The definition may be loaded into memory, read by a game program, or the like. In one embodiment, the definition may be personalized based on the identity of the player and/or capabilities of the client/mobile device. For example, a rotation pattern requiring less animation may be provided for a player who has indicated such a preference and/or for a client/mobile device with lower graphics capabilities. A rotation pattern requiring more animation may be provided for a client/mobile device with higher graphics capabilities. In another embodiment, the client/mobile device may be configured to personalize the definition on the device. For example, the player may capture an image with a camera and update the definition with the captured image. Processing then continues to block 406.

At block 406, a display of the client/mobile device is arranged to include a plurality of concentric rings. In one embodiment, the plurality of concentric rings is rendered on the display. In one embodiment, at least one of the concentric rings is nested within another one of the concentric rings. In one embodiment, at least one of the plurality of the concentric rings is offset from a center of the display. At least one of the plurality of concentric rings may also have a thin side and a thick side. In one embodiment, a plurality of client/mobile devices may receive the same game definition to enable a multi-player online tournament mode. In this embodiment, each definition may limit the game to the same time limit.

In one embodiment, at least a portion of the content is displayed on at least one of the concentric rings. In one embodiment, the content is associated with a level of the game. In one embodiment, a number of distinct parts of the content increases with the level of the game. In one embodiment, each portion of the content displayed on each associated concentric ring is configured to rotate with the associated concentric ring. In one embodiment, at least one rotation of the plurality of concentric rings is in a 90 degree increment (e.g., 0, 90, 180, 270, 360). However, in another embodiment, the concentric rings may rotate at different degree increments, and/or different concentric rings may rotate at different degree increments from each other. Processing then continues to block 408.

At block 408, at least one of the plurality of concentric rings that the at least one portion of the content is displayed on is rotated, and/or otherwise initialized. In one embodiment, an initial ordering of the at least one portion of the displayed content is changed by a rotation of the at least one of the plurality of the concentric rings that is rotated. In one embodiment, an initial ordering of the at least one of the plurality of concentric rings is based on a rotation pattern associated with the level of the game. Processing then continues to block 410.

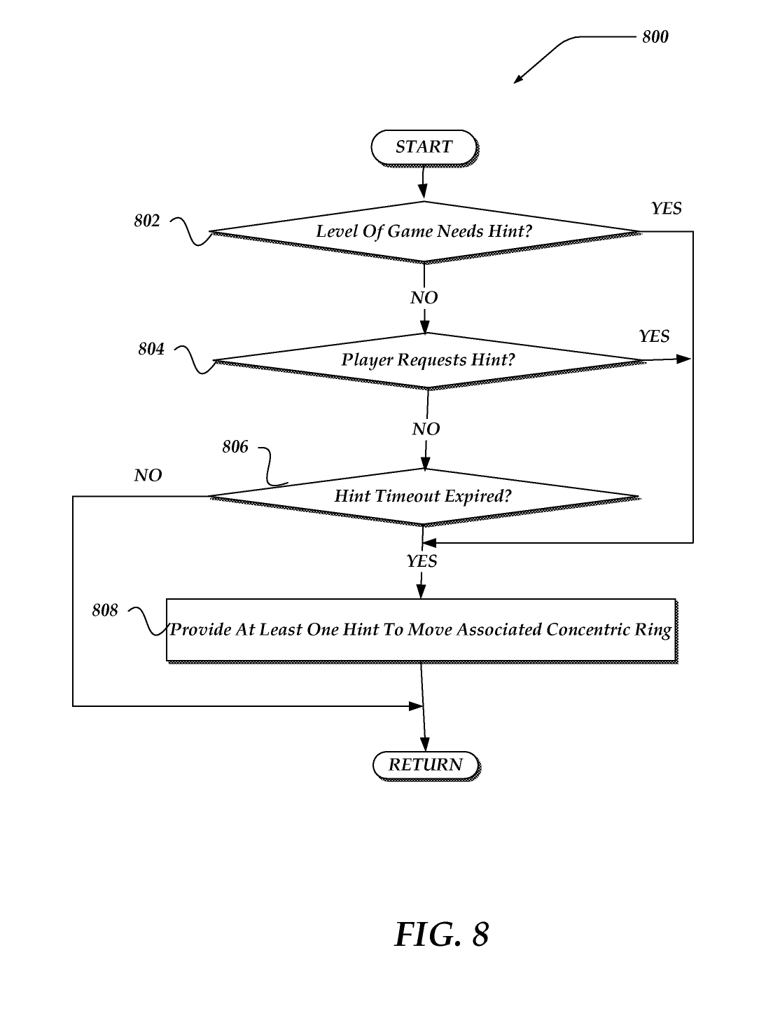

At block 410, a hint for a concentric ring to move is provided. A rotation of the hinted concentric ring may enable completion of the game. Block 410 may be performed by process 800 of FIG. 8. In one embodiment, block 410 may be optional and not performed (e.g., for advanced players). Processing then continues to block 412.

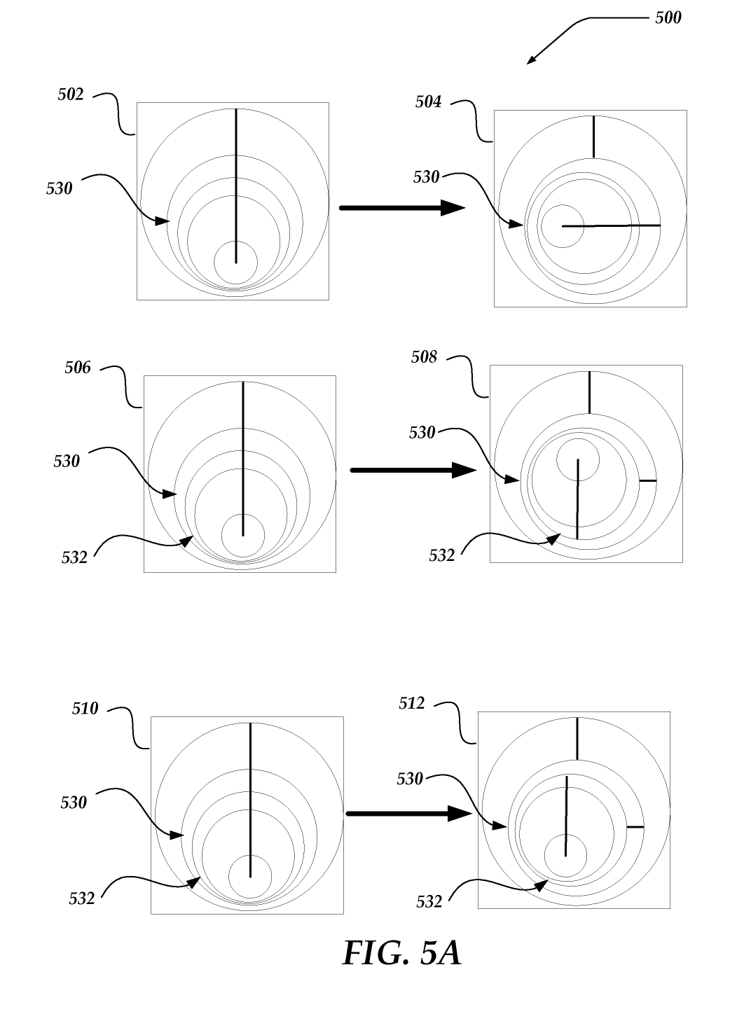

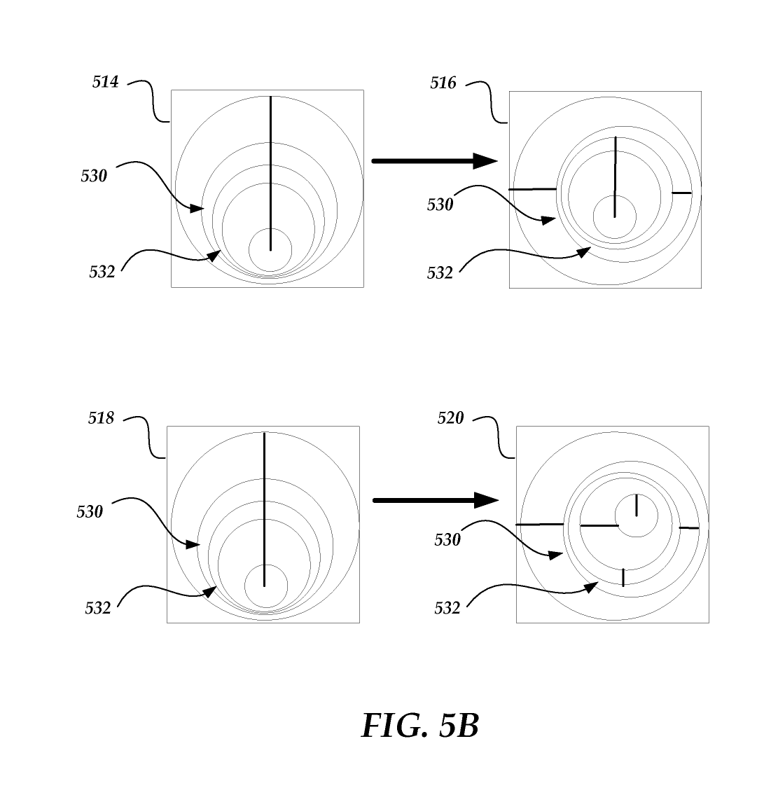

At block 412, entry of a plurality of inputs is enabled, or otherwise received on the computing device. In one embodiment, at least one input enables rotation of at least one of the plurality of concentric rings. In one embodiment, the concentric ring is selected with the entry of the input. In one embodiment, rotation of a selected parent ring may cause rotate of other child rings, based on a plurality of rotation patterns. The process for rotating is described more detail in conjunction with FIGS. 5A-5B. Briefly, for one rotation pattern, a parent ring of the plurality of concentric rings may be rotated. In response, for each orientation of each child concentric ring included within the parent ring, an orientation relative to the parent ring is maintained. For another rotation, a selected ring of the plurality of concentric rings is rotated. In response, another ring of the concentric rings relative to the selected ring is rotated. Processing then continues to decision block 414.

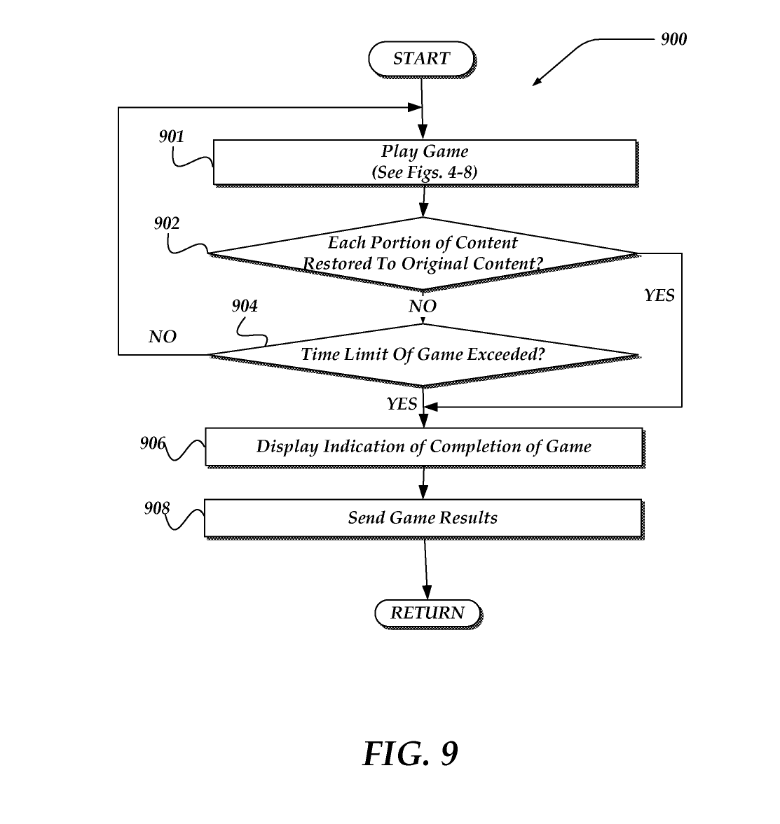

At decision block 414, it is determined if the game has been completed. A plurality of conditions may determine whether the game has been completed. The process for determining completion of the game is described in more detail in conjunction with FIG. 9. Briefly, the game may be determined to be completed if each portion of the content displayed on the plurality of concentric ring is restored as the original content defined in the definition (e.g., rearranged/realigned to form the original content). Processing then returns to a calling process for further processing.

FIGS. 5A and 5B show a plurality of processes for applying a plurality of rotation rules to enable changing a configuration of a concentric puzzle video game. A first configuration 502 comprises a series of rings nested progressively within each other. Each ring is offset from the other so that at least one of the rings has a thin and a thick side. At least one ring can rotate. At least one ring is selected as the parent ring. A player controls the rotation of the selected ring. The rotation of a ring may affect another ring in the puzzle, based on a plurality of relationships, and based on whether a ring is a parent or child of the rotating selected ring. The change from configuration 502 to configuration 504 shows an example of a rotation of a selected parent ring causing the child ring to rotate. As shown in configuration 504, the second ring 530 has rotated 90 degrees. In response, all the children rings inside it have followed (e.g., maintained the child ring's orientation relative to the parent ring).

The change from configuration 506 to configuration 508 shows how added complexity in the game control is introduced if a child ring reacts to the changing of a parent ring. In configuration 508, the second ring 530 rotates clockwise 90 degrees, and the third ring 532 rotates an additional 90 degrees. Therefore, the third ring 516 and its children rotate a total of 180 degrees.

The change from configuration 510 to configuration 512 shows how both positive and negative rotation values can govern the rotation of children rings. As shown in configuration 512, as the selected second ring 530 rotates 90 degrees, and as in reaction, the third ring 532 rotates −90 degrees. Thus, the third ring 532 appears not to move at all.

The change from configuration 514 to configuration 516 shows how the complexity of the game control may be increased if the children rings that are both inside and outside the selected ring are affected by the rotation of the selected ring. As shown in configuration 516, the second ring 530 is selected, and it rotates 90 degrees. In response, the third ring 532 rotates −90, and the first ring rotates −180.

The change from configuration 518 to configuration 520 shows how further complexity of the game control may be increased if all children rings are changed in response to changing the parent ring. As shown in configuration 520, the second ring 530 rotating 90 degrees causes all the children to rotate at different degree rotations. For example, the pattern of rotation may be represented in this manner: first ring: −180; second ring: 90; third ring: 90; fourth ring: 90; fifth ring: 90.

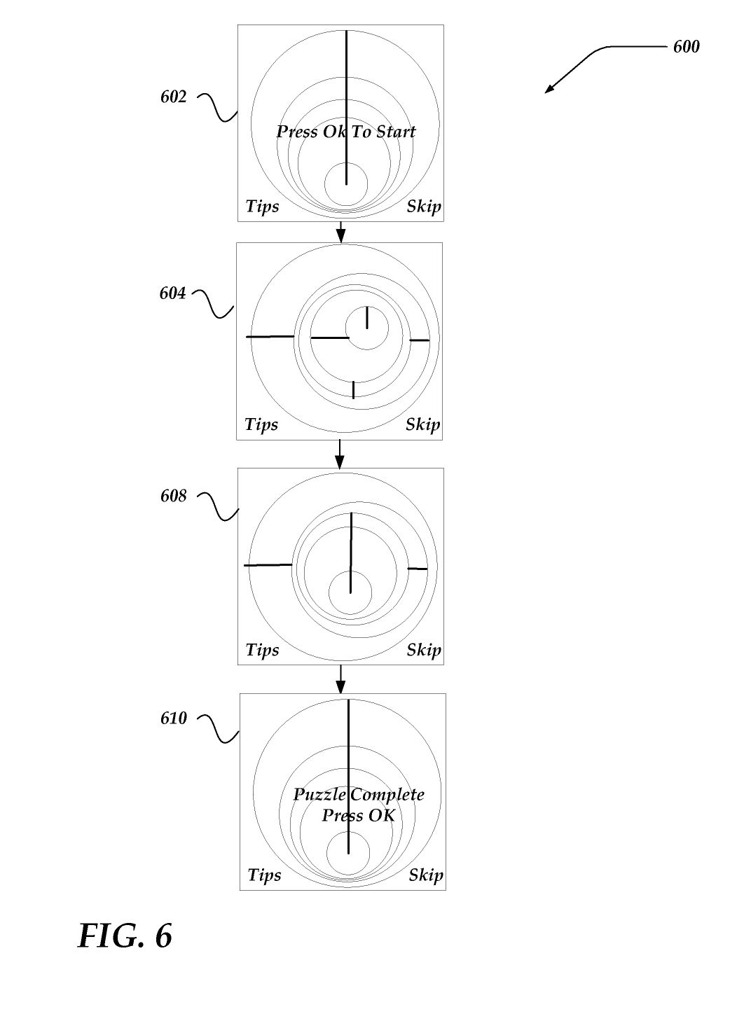

FIG. 6 shows another process flow diagram generally showing one embodiment of a process for enabling control of a concentric puzzle video game. FIG. 6 shows a display screen associated with each step of the process. Process 600 begins at display 602 where the puzzle, in its solved position, is displayed. If a player presses the start button, processing continues to display 604.

At display 604, a plurality of the rings of the puzzle rotates based on a rotation pattern associated with the puzzle and the level of the game. As shown, the portion of the content displayed on each of the rings rotates with the rings. Once the initialization of the puzzle completes, processing continues to display 606.

At display 606, one ring will flash to notify the player that it is the selected ring. The player uses the number pad to change which ring is selected. Pressing OK will cause the selected ring to rotate, and other rings will follow, based on a rotation pattern of the puzzle. In one embodiment, a different puzzle may be associated with a different rotation pattern.

The player may be enabled to enter inputs to the game device (e.g., mobile device) to rotate at least one of the rings. For example, processing may continue to display 608 after the player has entered a plurality of inputs to control the rotation of the rings. If each portion displayed on each ring is restored to the original content, processing continues to display 610.

In one embodiment, the player's goal is to realign the puzzle's content in the fewest moves. As shown in display 610, realigning the puzzle content results in a completed puzzle. Moreover, the time and number of moves made may also be displayed. Pressing OK takes the player to the next puzzle in the level. In one embodiment, the game may comprise 20 puzzles. For example, five puzzles may be allocated per four levels of difficulty. When a player completes all puzzles in a level, a level Complete Screen (now shown) is displayed, enabling the player to move to the next level of the concentric puzzle video game.

In an alternate embodiment, once the player has completed all levels of the game, the player may be enabled to play a championship mode. In the championship mode, the player must solve at least one puzzle within a time limit. If a time limit is expired while the player is entering inputs to control the rotation of the rings, the game may complete.

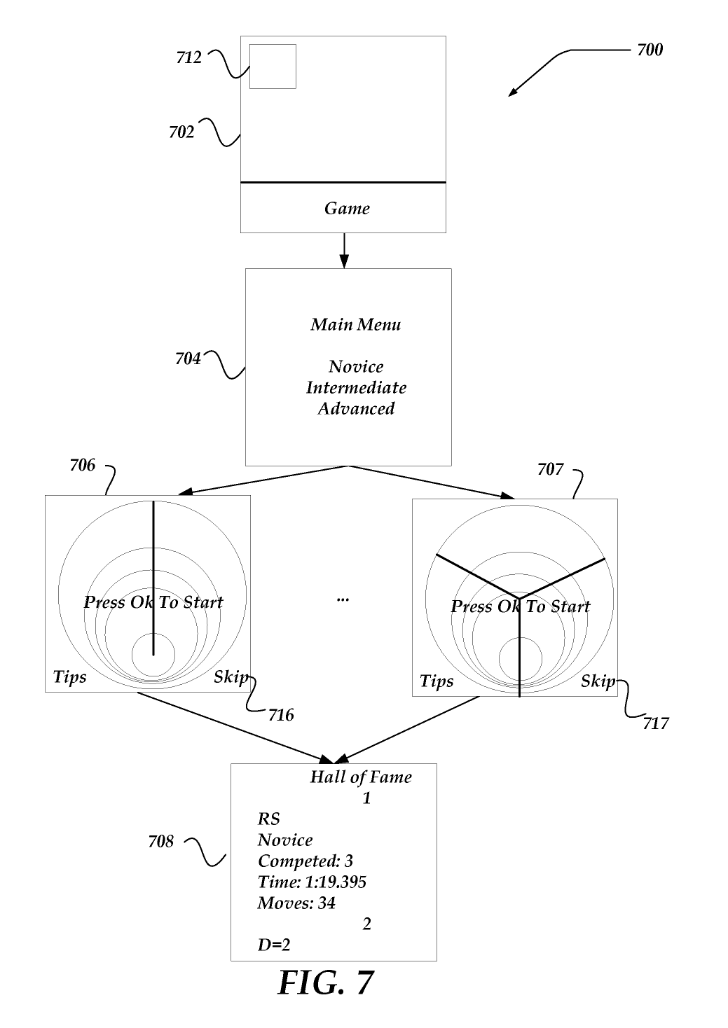

FIG. 7 shows an example of a process flow through a plurality of control screens for selecting and controlling the game. The process shown in FIG. 7 may be implemented with mobile devices 102-104, client device 101, and/or game server 106 of FIG. 1. The player may use discrete or analog input to control the selection of items in the menus shown in process 700. For example, the input may include key-presses, roll buttons, voice commands, touch screen commands, or the like.

Processing begins at Desktop 702. Desktop 702 shows a desktop menu presented to a player. Desktop 702 may be displayed on a mobile device, a web browser, a client device, or the like. The player may select to start the game by selecting the game icon 712.

Selecting the icon 712 brings the player to the Main Menu 704. As shown, Main Menu 704 presents the player with a selection of a plurality of different levels. At Main Menu 704, the player can select a level of play. In one embodiment, levels above Novice are locked until the player solves the previous level.

If the player selects a level, processing continues to one of a plurality of Game Screens 706-707 associated with the selected level. As shown, the first puzzle of that level of Game Screen 706 is presented in its Solved Position. Similarly, the first puzzle for Game Screen 707 is presented. In one embodiment, Game Screen 707 is a more difficult level than Game Screen 706. Puzzles become progressively more difficult by using increasingly more complex rotation patterns and/or an increased number of rings. In one embodiment, the number of distinct parts of the content increases with a degree of difficulty of the game. The player can “skip” to any puzzle within that level by selecting the skip button 716-717.

When the OK button is pressed, the puzzle content scrambles (e.g., orientations of the rings are initialized based on a rotation pattern) and the player is enabled to play the game. One embodiment for a process for playing the game is described in conjunction with FIGS. 4-6.

After the game play is complete (e.g., the player completes a plurality of puzzles in a level or a time limit expires), “Hall of Fame” display 708 may be displayed. Overall time and number of moves are displayed in display 708. Such information associated with the game may be saved and may be entered in a Hall Of Fame list to be displayed on display 708. In one embodiment, players can compete on the same device. Players who score higher points by finishing the game in a shorter amount of time, fewest moves, or the like, may be displayed higher in the list.

FIG. 8 shows a process for providing a hint for a concentric ring to be moved. Process 800 of FIG. 8 may be performed at block 410 of FIG. 4. Process 800 begins, after a start block, at decision block 802, where it is determined if a level of the game needs, indicates, or otherwise is required to provide a hint to a player. In one embodiment, a definition of the game may indicate whether a game played at the level will need to provide the hint. If the level needs the hint, then process continues to block 808. Otherwise, processing continues to decision block 804.

At decision block 804, it is determined whether a player requests a hint. In one embodiment, the hint may be provided when prompted by the player (e.g., through a key-press). If it is determined that the player has requested the hint, processing continues to block 808. Otherwise, processing continues to block decision 806.

At decision block 804, it is determined whether hint timeout has expired. In one embodiment, if a player has not made a move within the timeout, the timeout expires. If it is determined that the timeout has expired, processing continues to block 808. Otherwise, processing returns to a calling process for further processing.

At block 808, at least one hint associated with a concentric ring to move may be provided. A rotation of the hinted concentric ring may enable completion of the game. In one embodiment, the hint may be provided as a chime, sound, highlight of the hinted ring, a textual indication, or the like. In one embodiment, a portion of the content displayed on the concentric ring to be moved may be changed, to flash, to become a different color, or the like. Processing then returns to a calling process for further processing.

FIG. 9 shows a process for determining completion of the concentric puzzle video game. Blocks 902, 904, 906, and 908 of FIG. 9 may be performed at decision block 414 of FIG. 4. Process 900 begins, after a start block, at decision block 901, where the concentric puzzle video game is played on a computing device. Block 901 may be performed by process 400 of FIG. 4. Processing then continues to decision block 902.

At block 902 it is determined if each portion of the content displayed on an associated concentric ring is restored to the original content provided in a definition of the game. If the original content (e.g., image) is restored, processing continues to block 906. Otherwise, processing continues to decision block 904.

At decision block 904, it is determined if a time limit of game has been exceeded. In one embodiment, the time limit may be associated with the game, player, and/or level of difficulty of the game, or the like. If the time limit has been exceeded, processing continues to block 906. Otherwise, processing loops back to block 901 for further processing.

At block 906, an indication for a completion of the game is displayed. In one embodiment, the indication may comprise the game results. The game results may include statistics, including the display of a score based on a number of inputs entered for the game. In one embodiment the game play may be disabled at block 906. Processing then continues to decision block 908.

At block 908, the game results may be sent to a server for incorporation into statistics, comparison, storage, or the like. In one embodiment, the game results may be forwarded by the server to other devices (e.g., through the game application, a browser, email, or the like). In another embodiment, the client/mobile device may forward the game results to other devices of other players directly through, for example, SMS, email, or the like. In one embodiment, the game results may be from a multi-player online tournament mode. Processing then returns to a calling process for further processing.

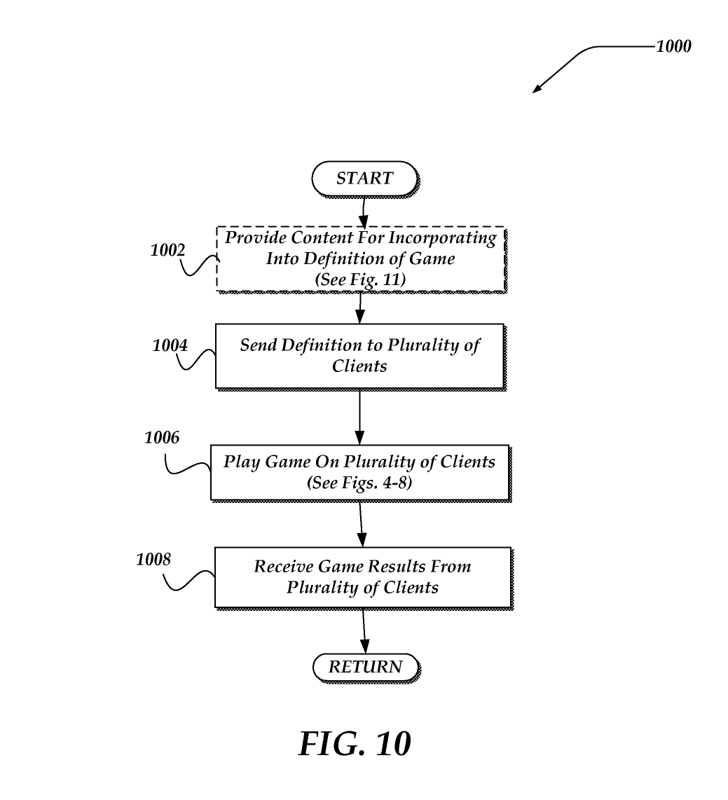

FIG. 10 shows a process for enabling a multi-player online tournament mode of the concentric puzzle video game. Process 1000 begins, after a start block, at block 1002, where content is provided to the server to personalize a definition of the game. The process of block 1002 is described in more detail in conjunction with FIG. 11. In one embodiment, block 1002 may be optional and may not be performed. Processing then continues to block 1004.

At block 1004, the (personalized) definition may be sent to a plurality of clients. In one embodiment, the plurality of clients receives the same definition, including the same timeout limit for a game, same content, and the like. Processing continues to blocks 1006.

At block 1006, a plurality of games is played on a plurality of client devices. The process of playing the game is described in more detail in conjunction with FIGS. 4-8. In one embodiment, each of the games may be played at the same time. After completion of the games, processing continues to block 1008.

At block 1008, each of the clients may send a game result to the server, and the game results may be received at the server. In one embodiment, the server may aggregate the game results into a statistic about a tournament played by the plurality of clients, e.g., the highest scoring player, the fastest player, or the like. Processing then returns to a calling process for further processing.

FIG. 11 shows a process for personalizing and/or customizing content and a game definition of a concentric puzzle video game. Process 1101 begins, after a start block, at decision block 1102, where content is captured on a client device, such as one of client devices 101-104 of FIG. 1. Content may be captured through an I/O device, camera, microphone, or the like. Processing then continues to block 1104.

At block 1104, the captured content may be modified or otherwise customized. In one embodiment, the content may be modified on the client device. In another embodiment, the content may be sent to the server and modified on the server. The content may be modified over a network, or the like. Modification may comprise compression, skewing, shrinking, cropping, filtering, or any other transcoding operation. In one embodiment, a game editor, such as game editor 244 of FIG. 2 may enable editing the content. Processing then continues to block 1106.

At block 1106, the game definition may be modified or otherwise customized. In one embodiment, the game definition may be modified on the client device. In another embodiment, the game definition may be sent to the server and/or modified on the server. The game definition may be modified over a network, or the like. Modification may comprise adding new levels, new rotation patterns, new rotation rules, or the like. In one embodiment, a game editor, such as game editor 244 of FIG. 2 may enable editing the definition of the game. Processing then continues to block 1108.

At block 1108, the content may be incorporated into the definition of the game. In one embodiment, the content may be included into a library, file, or the like, with the definition. In one embodiment, the content may be linked to by the file, or the like. In one embodiment, the content may be incorporated on the client device and/or sent to the server. In another embodiment, the content may be incorporated on the server. Thereby, the modified content may be personalized for a particular user. Processing then continues to block 1110.

At block 1110, the modified definition of the game may be shared with other client devices to enable a game play of the concentric puzzle video game based on the modified definition. Sharing may comprise sending the modified definition from the client to other client devices, from the client device to the server for further distribution to other client devices, posting the definition to a website for further download, or the like. In one embodiment, the player may restrict access to those who can receive the modified definition of the game. Processing then returns to a calling process for further processing.

It will be understood that each block of a flowchart illustration need not be limited in the ordering shown in the illustration, and might be performed in any ordering, or even performed concurrently, without departing from the spirit of the invention. It will also be understood that each block of the flowchart illustration, and combinations of blocks in the flowchart illustration, can be implemented by computer program instructions. These program instructions might be provided to a processor to produce a machine, such that the instructions, which execute on the processor, create means for implementing the actions specified in the flowchart block or blocks. The computer program instructions might be executed by a processor to cause a series of operational steps to be performed by the processor to produce a computer implemented process such that the instructions, which execute on the processor to provide steps for implementing the actions specified in the flowchart block or blocks.

Accordingly, blocks of the flowchart illustration support combinations of means for performing the specified actions, combinations of steps for performing the specified actions and program instruction means for performing the specified actions. It will also be understood that each block of the flowchart illustration, and combinations of blocks in the flowchart illustration, can be implemented by special purpose hardware-based systems which perform the specified actions or steps, or combinations of special purpose hardware and computer instructions.

### Illustrative Game Definition

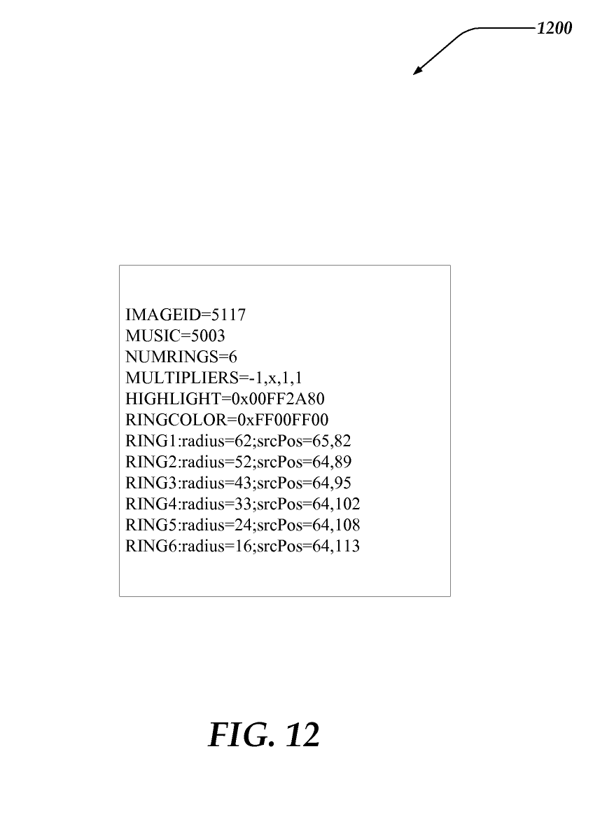

FIG. 12 an example definition for a concentric puzzle video game. As shown, the definition file may include an IMAGEID, MUSICID, NUMRINGS, MULTIPLIERS, RINGOCOLOR, and RING1-RING6. As shown, the IMAGEID is a code for an image (e.g., in an image file incorporated with the definition). MUSICID is a code for a music file to be played while the user is playing the game. In another embodiment, IMAGEID and/or MUSIC, may be a URL to other content for use with the game. MULTIPLIERS defines a rotation rule. MULTIPLIERS is a pattern that controls the rotation of the specified rings. The “X” represents the selected ring. The numbers before the “X” represents the rings surrounding the selected ring. The numbers after the “X” represents rings included inside the selected ring. The number shown represents multiples of 90 degrees. For example, 1 represents a 90 clockwise rotation. 2 represents a 180 clockwise rotation. −1 represents a 90 counter clockwise rotation. −2 represents a 180 counter clockwise rotation. 0 represents a 0 rotation. For the example shown, when a ring is selected, the selected ring rotates based on the device input. The next ring surrounding the selected ring rotates −90 degrees. The next ring included inside the selected ring rotates +90 degrees, and the next included ring rotates +90 degrees. RING1-RING6 defines the radius and center position of the ring. Although 6 rings are shown, more rings, or rings of different shapes (triangles, squares, or the like), may be used without departing from the scope of the invention.

The above specification, examples, and data provide a complete description of the manufacture and use of the composition of the invention. Since many embodiments of the invention can be made without departing from the spirit and scope of the invention, the invention resides in the claims hereinafter.

What is claimed as new and desired to be protected by Letters Patent of the United States is:

1. A method for playing a game on a computing device, comprising:
employing a definition to arrange at least one operation of the game and a display of the game, wherein the definition includes content for configuring the display of the game;
arranging the display of the game on the computing device to include a plurality of concentric rings, wherein at least a portion of the content is displayed on at least one of the concentric rings;
rotating at least one of the plurality of concentric rings that the at least one portion of the content is displayed on, wherein an initial ordering of the at least one portion of the displayed content is changed by a rotation of the at least one of the plurality of the concentric rings; and
enabling an input on the computing device to rotate a selected ring of the plurality of concentric rings, wherein the initial ordering of the at least one portion of the displayed content is restorable by the input.

2. The method of claim 1, further comprising:
maintaining for each orientation of each child concentric ring included within the selected ring substantially the same orientation relative to the selected ring.

3. The method of claim 1, further comprising:
rotating another ring of the plurality of concentric rings relative to the selected ring.

4. The method of claim 1, wherein a number of distinct parts of the at least one portion of the displayed content increases with a level of the game.

5. The method of claim 1, wherein rotating the at least one of the plurality of concentric rings is based on a rotation pattern associated with a level of the game.

6. The method of claim 1, wherein the content comprises audio, video, image, or animation.

7. The method of claim 1, further comprising:
providing a hint for moving another one of the plurality of concentric rings to enable restoring the displayed content.

8. The method of claim 1, further comprising:
receiving the definition by at least another computing device configured to play the game within a same time-limit included in the definition; and
providing an aggregation of game results of at least two of the games played on the computing devices.

9. The method of claim 1, further comprising:
providing other content to be incorporated into the definition; and
sharing the modified definition with at least another computing device for playing a game based on the modified definition.

10. A mobile device for playing a game, comprising:
a display for rendering data; and
a processor configured to perform actions comprising:
receiving a definition to arrange at least one operation of the game and the display, wherein the definition includes content for configuring the display;
arranging the display to include a plurality of concentric rings, wherein at least a portion of the content is displayed on at least one of the concentric rings;
rotating at least one of the plurality of concentric rings that the at least one portion of the content is displayed on, wherein an initial ordering of the at least one portion of the displayed content is changed by a rotation of the at least one of the plurality of the concentric rings; and
enabling an input to rotate a selected ring of the plurality of concentric rings, wherein the initial ordering of the at least one portion of the displayed content is restorable by the input.

11. The mobile device of claim 10, wherein rotating the at least one of the plurality of concentric rings further comprises:
rotating another ring of the concentric rings relative to a selected ring based on a rotation rule.

12. The mobile device of claim 10, wherein the actions further comprises:
changing a number of the plurality of concentric rings based on a level of the game

13. The mobile device of claim 10, wherein a center of at least one of the plurality of the concentric rings is displayed at an offset from a center of the display, and wherein at least one of the plurality of the concentric rings has a thick side and a thin side.

14. The mobile device of claim 10, wherein the actions further comprises:
providing an indication of a completion of the game if each portion of the content displayed on each associated concentric ring is restored to the content included in the definition.

15. The mobile device of claim 10, wherein the actions further comprises:
providing a hint for moving another one of the plurality of concentric rings to enable restoring the displayed content.

16. The mobile device of claim 10, wherein the actions further comprises:
capturing other content through at least one input device on the mobile device; and
modifying the other content and the definition; and
sharing the modified content and the modified game definition with another device for playing another game.

17. The mobile device of claim 10, wherein the definition is configured to enable playing the game on the mobile device and another device, and wherein the actions further comprises providing the game results for aggregation.

18. The mobile device of claim 10, wherein the actions further comprises:
personalizing the definition; and
sharing the personalized definition over a network for playing another game based on the modified definition.

19. A processor readable medium for playing a game on a computing device, comprising data, wherein the data is executable by a processor to perform actions comprising:
employing a definition to arrange at least one operation of the game and a display of the game, wherein the definition includes content for configuring the display of the game;
arranging the display of the game on the computing device to include a plurality of concentric rings, wherein at least a portion of the content is displayed on at least one of the concentric rings;
rotating at least one of the plurality of concentric rings that the at least one portion of the content is displayed on, wherein an initial ordering of the at least one portion of the displayed content is changed based on a rotation pattern and a rotation of the at least one of the plurality of the concentric rings; and
enabling an input on the computing device to rotate a selected ring of the plurality of concentric rings, wherein the initial ordering of the at least one portion of the displayed content is restorable by the input and a rotation rule.

20. The processor readable medium of claim 19, wherein the actions further comprises:
providing a hint for moving another one of the plurality of concentric rings to enable restoring the displayed content.

21. The processor readable medium of claim 19, wherein the actions further comprises:
receiving the definition by at least another computing device configured to play the game within a same time-limit included in the definition; and
providing an aggregation of game results of the game.

22. The processor readable medium of claim 19, wherein the actions further comprises:
providing other content to be incorporated into the definition; and
sharing the modified definition with at least another computing device for playing another game based on the modified definition.

23. A system for playing a game over a network, comprising:
a server device configured to perform actions comprising:
providing a definition to arrange at least one operation of the game and a display of the game, wherein the definition includes content for configuring the display of the game and further includes a time-limit for playing the game; and
a plurality of client devices in communication with the server device, wherein each of the client devices are configured to perform the actions comprising:
receiving the definition over the network;
arranging the display of the game to include a plurality of concentric rings, wherein at least a portion of the content is displayed on at least one of the concentric rings;
rotating at least one of the plurality of concentric rings that the at least one portion of the content is displayed on, wherein an initial ordering of the at least one portion of the displayed content is changed based on a rotation pattern and a rotation of the at least one of the plurality of the concentric rings; and
enabling an input to rotate a selected ring of the plurality of concentric rings, wherein the initial ordering of the at least one portion of the displayed content is restorable by the input and a rotation rule.

24. The system of claim 18, wherein the client device is further configured to perform actions comprising:
providing a hint for moving another one of the plurality of concentric rings to enable restoring the displayed content.

25. The system of claim 18, wherein the client device is further configured to perform actions comprising:
providing other content to be incorporated into the definition; and
sharing the modified definition with at least one of the plurality of client devices for playing another game based on the modified definition.
